(19) United States
(12) Patent Application Publication
(10) Pub. No.: US 2020/0001981 A1
(43) Pub. Date: Jan. 2, 2020

(54) JET FLOW CONTROL MECHANISM AND METHOD OF USE

(71) Applicant: Khaled Abdullah Alhussan, Riyadh (SA)

(72) Inventor: Khaled Abdullah Alhussan, Riyadh (SA)

(21) Appl. No.: 16/455,048

(22) Filed: Jun. 27, 2019

Related U.S. Application Data
(60) Provisional application No. 62/690,680, filed on Jun. 27, 2018.

(51) Int. Cl. B64C 21/04; B64C 30/00; F15D 1/00

(52) U.S. Cl. CPC B64C 21/04; B64C 2230/04; F15D 1/008; B64C 30/00

(57) ABSTRACT

A transonic aircraft includes a frame body extending from a fuselage to a rear tail wing section; an engine placed between the fuselage and rear tail wing section, the engine is secured to the frame body; a wing section includes a wing body with an upper surface and a lower surface that extend from a leading edge to a trailing edge, the wing body is oriented at an angle relative to an elongated length of the frame body; and a flow separation control device secured to the wing section. The flow separation control device includes a plurality of openings on the upper surface of the wing body.

### BACKGROUND

### 1. Field of the Invention

The present invention relates generally to transonic aircraft, and more specifically, the present invention is related to a transonic aircraft with engines positioned at selective locations on the main body along with a system and method to control flow separation utilizing a process of injecting fluid and/or gas into a separated boundary layer to reduce, if not eliminate, the boundary layer separation near the trailing edge of the airfoil during flight.

### 2. Description of Related Art

Aircrafts are well known in the art and are effective means to manipulated gas and/or fluid within an airstream to create lift and flight. In one embodiment, the aircraft includes a plurality of airfoil that are utilized to create lift for an aircraft 101, as depicted in FIG. 1. In the exemplary embodiment, the aircraft 101 includes a body 103 having two wing sections 105, 107 rigidly attached thereto and extending from body 103. On each wing section 105, 107 is one or more engines 109, 111 configured to provide necessary thrust to achieve flight.

One of the problems commonly associated with aircraft 101 is the limited use during different flight regimes and for achieving desired speeds. It should be understood that the conventional aircraft designs are not optimized for all flight regimes (subsonic, transonic, and supersonic). Conventional aircrafts are designed according to one optimal cruise speed. The efficiency of usual aircraft performance is maximum at a certain flight regime for which it is specifically designed.

Methods to control the jet stream around an aircraft is also well known in the art. It should be understood that attempting to control the airstream of an aircraft during different flight regimes could result in catastrophic failure. One of the problems commonly associated with conventional aircrafts is the limited use during different flight regimes as conventional aircraft are not designed for all flight regimes (subsonic, transonic, and supersonic). Conventional aircrafts are designed according to one optimal cruise speed. The efficiency of usual aircraft performance is maximum at a certain flight regime for which it is specifically designed.

Further, conventional aircraft experience significant flow separation at different flight regimes. It should be understood that flow separation can occur near the trailing edge of the airfoil during different flight regimes, which in turn results in the flow separation greatly reduces the efficiency of the aircraft performance.

Accordingly, although great strides have been made in the area of aircraft and increasing flight performance, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a top view of a conventional aircraft;

FIGS. 2, 3, and 4 are respective oblique, top, and side views of an aircraft in accordance with a preferred embodiment of the present application;

FIGS. 5, 6, and 7 are respective oblique, top, and side views of an aircraft in accordance with an alternative embodiment of the present application;

FIGS. 8, 9, and 10 are respective oblique, top, and side views of an aircraft in accordance with an alternative embodiment of the present application;

FIG. 11 is a flowchart depicting the preferred method of use;

FIGS. 12 and 13 are side cross-sectional view of the wing of the aircraft of FIG. 3 taken at A-A; and

FIG. 14 is a chart of preferred dimensions of the present invention.

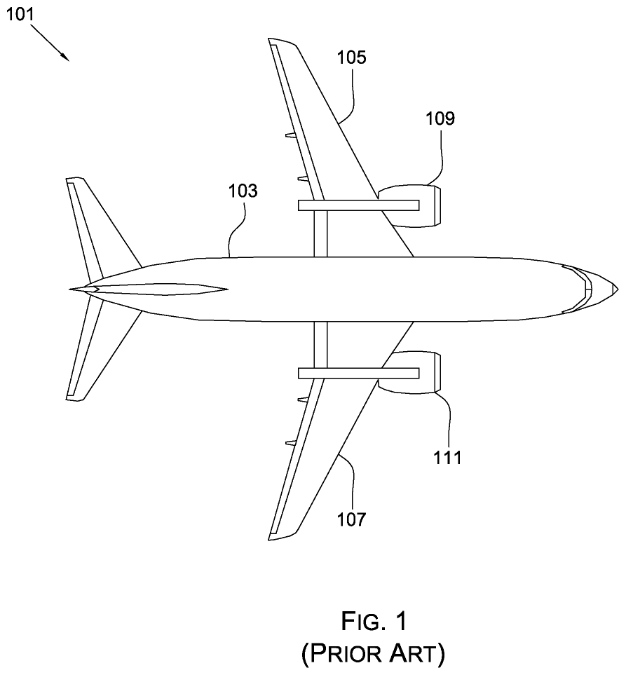

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present application incorporates one or more features of the systems and methods to reduce flow separation over an airfoil as discussed in the previously filed parent application, which the present application incorporates by references and claims are priority. It should be understood that an airfoil is determined as any wing and/or structure of the aircraft that creates lift or any surface structure affected by the airstream traveling around the aircraft.

The system and method of use in accordance with the present application overcomes one or more of the above-discussed problems commonly associated with conventional aircraft. The present invention is related to a transonic aircraft having selective engine locations near the rear of the aircraft. The present invention is also related to a system and method to control flow separation utilizing a method of injecting fluid and/or gas into a separated boundary layer to reduce, if not eliminate, the boundary layer separation near the trailing edge of the airfoil during flight. This feature is achieved by channeling fluid and/or gas through a porous membrane on the top surface of the airfoil and positioned to inject fluid and/or gas into and/or near the separated boundary layer. In one preferred embodiment, the fluid and/or gas is channeled through a plurality of capillary tubes extending through the skin of the airfoil. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

Referring now to the drawings wherein like reference characters identify corresponding or similar elements throughout the several views, FIGS. 2-4 depicts various views of a transonic aircraft 201 and flow control devices 301, 303 in accordance with one preferred embodiment of the present application. It will be appreciated that aircraft 201 overcomes one of more of the above-listed problems commonly associated with conventional aircrafts. The present invention enables an aircraft to travel from subsonic to transonic and to supersonic speeds without loss of efficiency. With the present invention, there can be multiple optimized cruise speeds between Mach Numbers 0.9-1.2 by control of the flow injection into the free stream over the various components of the aircraft.

In the contemplated embodiment, aircraft 201 includes one or more of an aircraft body 203 extending from a fuselage 205 to a rear tail section. Two wing sections 217, 219 rigidly attach to and extend from body 203 in a manner illustrated in the illustrated figures. In one preferred embodiment, both the tail wings and the main wing sections are oriented at the same angle relative to each other and relative to the longitudinal length of the body. In one embodiment, the tips of the wing sections extend at a ratio of about 872.48/1011.39 to the tip of the rear wing section relative to the front nose of the aircraft. Further, the wing section span has a ratio of about 721.59/241.41 relative to the wing span of the rear wing section.

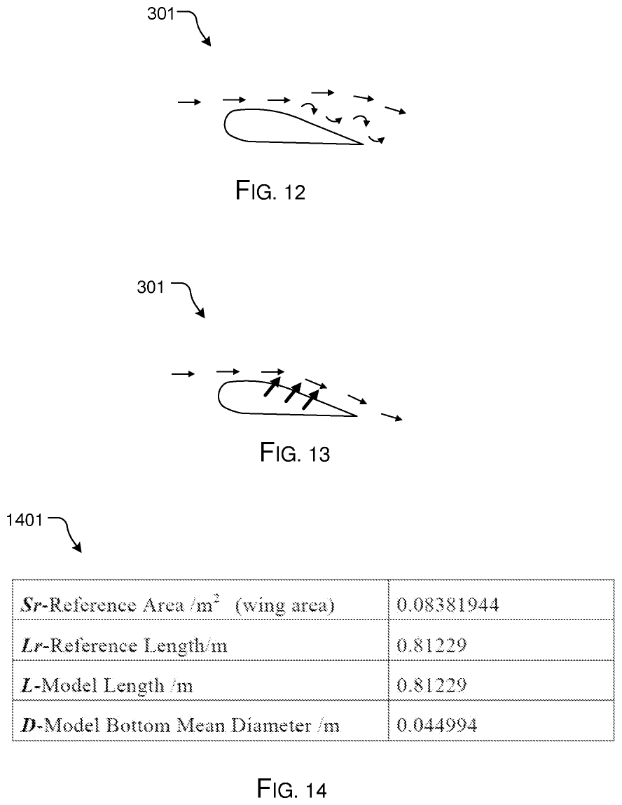

One of the unique features of the present embodiment is the placement of the intake engines 207a, 207b between the wing sections 217, 219 and the rear tail section. In the exemplary embedment, the engines 207a, 207b are positioned proximate to the wing sections. During use, the engines 207a, 207b provide the necessary trust for flight. In the preferred embodiment, the locations of the engines are positioned at selected locations to create minimum drag and maximum lift to drag ratio. Additional preferred dimensional information is shown in chart 1301 of FIG. 13.

As discussed above, the aircraft 201 is provided with flow control devices 301, 303 on the wing sections. Although shown with merely two flow control devices, it will be appreciated that alternative embodiments could include more or less flow control devices for each wing section. In the exemplary embodiment, the flow control devices are positioned at areas along the wing near the elongated body and at the tip of the wing sections. FIG. 12 illustrates a cross-sectional view of wing section 219 as the flow separation control device reduces the separated boundary layer.

One of the unique features believed characteristic of the present invention is the use of a separation flow control devices 301, 303 configured to manipulated the airflow around the upper surface of respective wing sections 219, 217, as depicted in FIGS. 12, during different flight regimes. To achieve this feature, the flow control device injects air and/or fluid within the airstream passing over the upper surface of the wing, as depicted with arrow “A” and “B” of FIG. 12. It should be understood that the process of injecting the fluid and/or air into the turbulent flow separation causes the separated boundary layer to partially, if not fully, reattach to the upper surface of the wing, which in turn increases the airfoil effective use during different flight regimes.

It has been found that the porous section of the flow control device 301 extends from ⅓ to ⅔ of the chord length of the wing length. Within this confined area, fluid and/or gas is injected into the airstream passing over the upper surface as discussed above. Although found effective within this section of the chord length, it will be appreciated that other embodiments could include sections with different chord lengths. In the exemplary embodiment, injection jets extend the entire upper surface of the wing section.

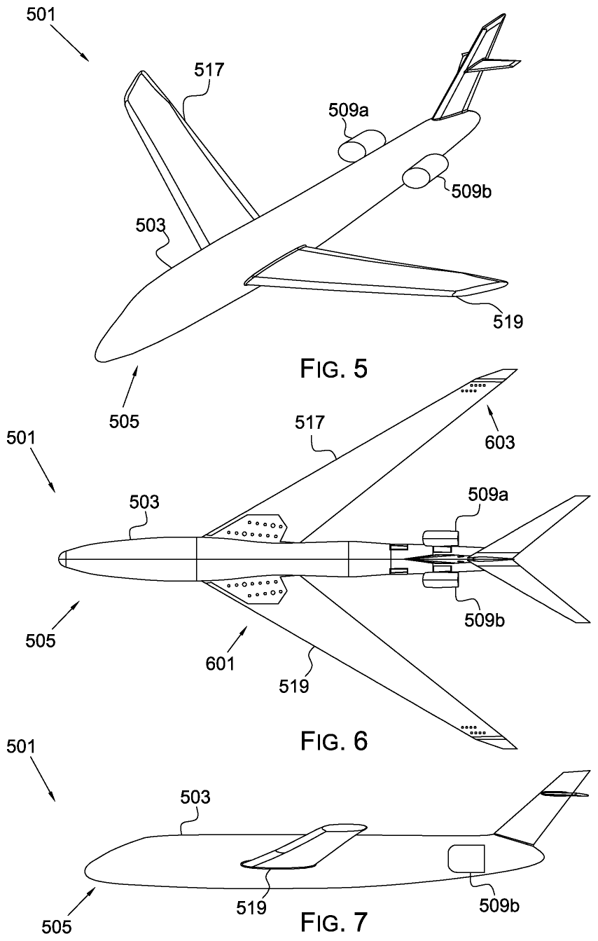

Referring now to FIGS. 5-7 in the drawings, respective oblique, top, and side views of an aircraft 501 is shown in accordance with an alternative embodiment of the present application. It will be appreciated that aircraft 501 includes one or more of the features of aircraft 201 discussed above.

In the exemplary embodiment, aircraft 501 includes an elongated body 503 with two wing sections 517, 519 rigidly attached to and extending from body 503. One or more flow separation control devices 601, 603 are secured to the wing sections and are configured to reduce the flow separation over the wing sections.

As discussed above, the engines are placed near the rear section of the body. In the alternative embodiment, the engines 509a, 509b are placed furthest back near the rear tail wings. This embodiment has shown to achieve optimum flight conditions.

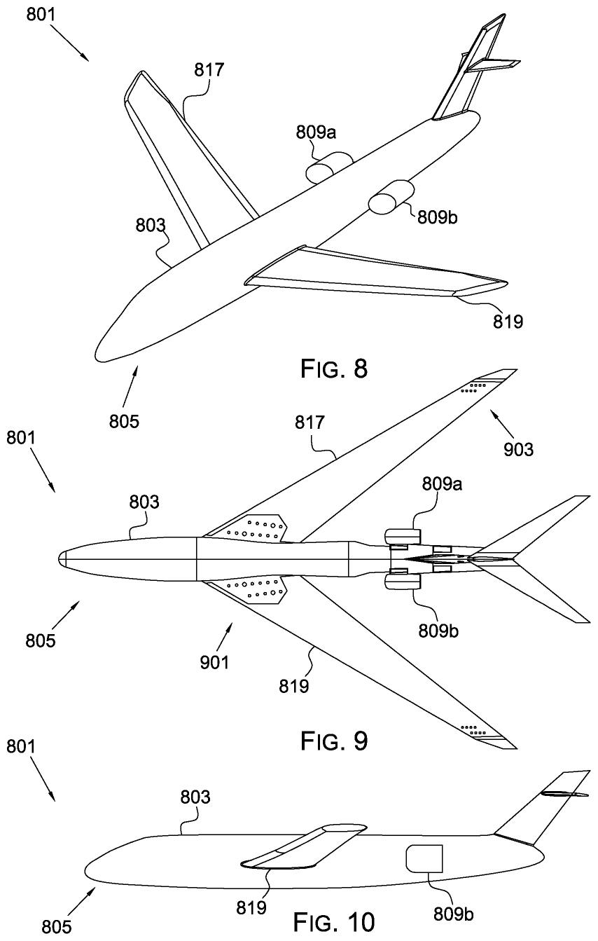

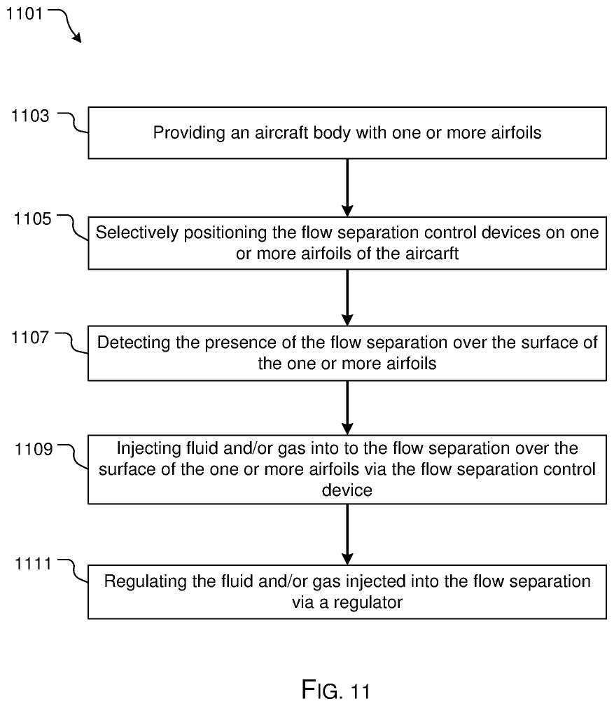

Referring now to FIGS. 8-10 in the drawings, respective oblique, top, and side views of an aircraft 80101 is shown in accordance with an alternative embodiment of the present application. It will be appreciated that aircraft 801 includes one or more of the features of aircraft 201 discussed above.

In the exemplary embodiment, aircraft 801 includes an elongated body 803 with two wing sections 817, 819 rigidly attached to and extending from body 803. One or more flow separation control devices 901, 903 are secured to the wing sections and are configured to reduce the flow separation over the wing sections.

As discussed above, the engines are placed near the rear section of the body. In the alternative embodiment, the engines 809a, 809b are placed furthest back near the rear tail wings. This embodiment has shown to achieve optimum flight conditions.

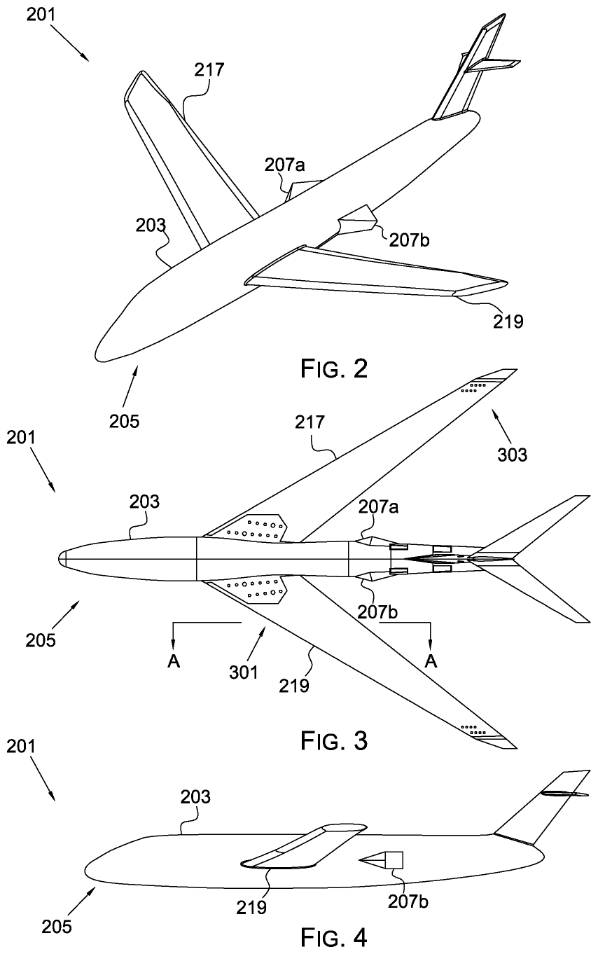

Referring now to FIG. 11 in the drawings, the preferred method of use is shown in flowchart 1101 and further detailed in boxes 1103-1111. The method of flow separation control is further shown as an illustrative embodiment in FIGS. 12 and 13, wherein side cross-sectional views of the wing section of the aircraft of FIG. 3 are shown taken at A-A. In the two figures, the operation of the flow separation control device is shown wherein the separated boundary layer over the upper surface of the wing is separated in FIG. 12 and re-attaches to the upper surface as gas and/or fluid is injected, as shown in FIG. 13.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. An aircraft, comprising:
a frame body extending from a fuselage to a rear tail wing section;
an engine placed between the fuselage and rear tail wing section, the engine is secured to the frame body;
a wing section; and
a flow separation control device secured to the wing section, the flow separation control device;
wherein a portion of the airstream passing over the upper surface of the wing body is affected by the plurality of openings; and
wherein the plurality of openings reduces a flow separation in the portion of the airstream passing over the upper surface of the body.

2. The aircraft of claim 1, the wing section comprising:
a wing body with an upper surface and a lower surface that extend from a leading edge to a trailing edge, the wing body is oriented at an angle relative to an elongated length of the frame body.

3. The aircraft of claim 2, the flow separation device, having:
a plurality of openings on the upper surface of the wing body;

4. The aircraft of claim 3, wherein the flow separation device extends the longitudinal length of the wing body.

5. The aircraft of claim 3, wherein the plurality of openings extend from a ⅓ chord length to a ⅔ chord length of the wing section.

6. The aircraft of claim 1, wherein the plurality of openings extend from a ⅓ chord length to a ⅔ chord length of the wing section.

7. The aircraft of claim 1, wherein the plurality of openings are in gaseous communication with a capillary tube extending through a thickness of the wing body.

8. The aircraft of claim 7, wherein gas is channeled through the capillary tube and passes through the opening into the airstream.

9. The aircraft of claim 8, wherein the capillary tube is oriented at an angle relative to the upper surface of the wing body.

10. The aircraft of claim 9, wherein the gas exits at an angle relative to the upper surface of the wing body.

11. The aircraft of claim 8, further comprising:
an injection system, having:
an inlet tube;
a pump in gaseous communication with the inlet tube; and
a flow regulator in gaseous communication with the pump and the tube;
wherein the pump directs the gas from the inlet tube to the capillary tubes; and
wherein the flow regulator regulates the flow rate of gas passing through the capillary tube.

12. The aircraft of claim 11, wherein the inlet tube is in fluid communication with a portion of the airstream passing over the lower surface of the wing section.

13. The aircraft of claim 11, further comprising:
a common air chamber in gaseous communication with a plurality of capillary tubes extending through the thickness of the body and in gaseous communication with the pump.

14. A method to achieve optimal flight within different flight regimes, comprising:
providing an aircraft having:
a frame body extending from a fuselage to a rear tail wing section;
a wing section, having:
a wing body with an upper surface and a lower surface that extend from a leading edge to a trailing edge, the wing body extending at an angle relative to the frame body; and
a flow separation control device secured to the wing section;
providing the flow separation control device with a plurality of openings on the upper surface of the wing body;
controlling the flow separation over the upper surface of the wing body via the flow separation control device;
controlling the flow separation via the plurality of openings; and
adjusting the flow separation control device as the aircraft changes between different flight regimes.

15. The method of claim 1, wherein the engine is position near the rear tail wing.

16. The method of claim 1, wherein the flow separation device extends the longitudinal length of the wing body.

17. The method of claim 1, wherein the plurality of openings extend from a ⅓ chord length to a ⅔ chord length of the wing section.

18. The method of claim 1, wherein the plurality of openings extend from a ⅓ chord length to a ⅔ chord length of the wing section.

19. The method of claim 1, wherein the plurality of openings are in gaseous communication with a capillary tube extending through a thickness of the wing body.

20. The method of claim 1, wherein gas is channeled through the capillary tube and passes through the opening into the airstream.

21. The method of claim 1, wherein the capillary tube is oriented at an angle relative to the upper surface of the wing body.

22. The method of claim 10, wherein the gas exits at an angle relative to the upper surface of the wing body.
